(19) United States
(12) Patent Application Publication
(10) Pub. No.: US 2026/0301346 A1
(43) Pub. Date: Oct. 1, 2026

(54) Automated Generation And Use Of Modified Dwelling Images Using Neural Network Models Of Multiple Types

(71) Applicant: MFTB Holdco, Inc., Seattle, WA (US)

(72) Inventor: Lambert E. Wixson, Bellevue, WA (US)

(21) Appl. No.: 19/577,129

(22) Filed: Mar. 24, 2026

Related U.S. Application Data
(60) Provisional application No. 63/777,599, filed on Mar. 25, 2025.

(51) Int. Cl. G06T 19/20; G06T 7/13; G06T 7/50; G06T 7/70; G06T 15/10; G06T 19/00

(52) U.S. Cl. CPC G06T 19/20; G06T 7/13; G06T 7/50; G06T 7/70; G06T 15/10; G06T 19/006; G06T 2200/24; G06T 2207/20081; G06T 2207/20084; G06T 2207/30244; G06T 2210/62; G06T 2219/2004; G06T 2219/2016

(57) ABSTRACT

Techniques are described for performing automated operations to generate and use modified dwelling images based on multiple trained neural network (NN) models of multiple types, such as to provide improved search results based at least in part on the modified dwelling images and on objects included within them. The multiple NN models may include a depth discontinuity NN model trained to generate a depth discontinuity map that identifies locations of nearby pixels in an image with differences in predicted depth values (e.g., for edge transitions from visible surfaces to other surfaces behind them), and an occlusion mask NN trained to generate an occlusion mask for the dwelling image for use in generating a modified version of the dwelling image including virtual object(s) and that includes per-pixel determinations of which of multiple source images to use for that pixel's value in the modified image.

### CROSS REFERENCE TO RELATED APPLICATIONS

This application claims the benefit of U.S. Provisional Patent Application No. 63/777,599, filed Mar. 25, 2025 and entitled “Automated Generation And Use Of Modified Dwelling Images Using Neural Network Models Of Multiple Types”, which is hereby incorporated by reference in its entirety.

### TECHNICAL FIELD

The following disclosure relates generally to techniques for automatically generating and using modified dwelling images based on multiple trained neural network models of multiple types, such as to automatically use a trained deep-learning neural network model to generate a depth discontinuity map for a dwelling image and to use a trained convolutional neural network model to use the depth discontinuity map to generate an occlusion mask for the dwelling image for use in generating a modified version of the dwelling image with per-pixel determinations of which of multiple sources to use for that pixel's value in the modified image, and to respond to search queries for dwellings using such modified dwelling images and the objects included within them.

### BACKGROUND

An abundance of information is available to users on a wide variety of topics from a variety of sources. For example, portions of the World Wide Web (“the Web”) are akin to an electronic library of documents and other data resources distributed over the Internet, with billions of documents available, including groups of documents directed to various specific topic areas (e.g., buildings of various types). In addition, various other information is available via other communication mediums. However, existing search engines and other techniques for identifying information of interest suffer from various problems. Non-exclusive examples include a difficulty in understanding natural language requests, difficulty in providing accurate information that is specific to a particular topic of interest and/or useful to a particular user, difficulty in limiting information requests to approved topics, etc.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1B are network diagrams illustrating an example system for performing described techniques, including automatically generating and using modified dwelling images based on multiple trained neural network models of multiple types.

FIG. 1C illustrates examples of non-exclusive types of dwelling description information.

FIGS. 2A-2C illustrate examples of performing described techniques, including automatically generating and using modified dwelling images based on multiple trained neural network models of multiple types.

FIG. 3 is a block diagram illustrating an example of a computing system for use in performing described techniques, including automatically generating and using modified dwelling images based on multiple trained neural network models of multiple types.

FIGS. 4A-4B illustrate a flow diagram of an example embodiment of an Automated Dwelling Image Occlusion Manager (“ADIOM”) system routine.

FIGS. 5A-5B illustrate a flow diagram of an example embodiment of an ADIOM Modified Image Generator component routine.

FIG. 6 illustrates a flow diagram of an example embodiment of a client device routine.

### DETAILED DESCRIPTION

The present disclosure describes techniques for using computing devices to perform automated operations involving automatically generating and using modified dwelling images based on multiple trained neural network models of multiple types, such as to provide improved search results that are based at least in part on the modified dwelling images and on the objects included within them. In at least some embodiments and situations, the modifications to a dwelling image showing at least part of a room of a dwelling include adding visual representations of one or more virtual objects to a modified version of the dwelling image, such as to add structural elements (e.g., walls, doorways, windows, etc. or holes in walls or other structural elements) to reflect structural changes to the room. The determination of which dwelling images to be modified and of what virtual objects to be added to such dwelling images at indicated placement locations within the rooms or other areas shown in the dwelling images may be made in various manners in various embodiments, including based at least in part on an automated analysis of visual data of a dwelling image in some embodiments, as discussed further herein. Additional details are included below regarding automatically generating and using modified dwelling images based on multiple trained neural network models of multiple types, and some or all of the techniques described herein may, in at least some embodiments, be performed via automated operations of an Automated Dwelling Image Occlusion Manager (“ADIOM”) system, as discussed further below.

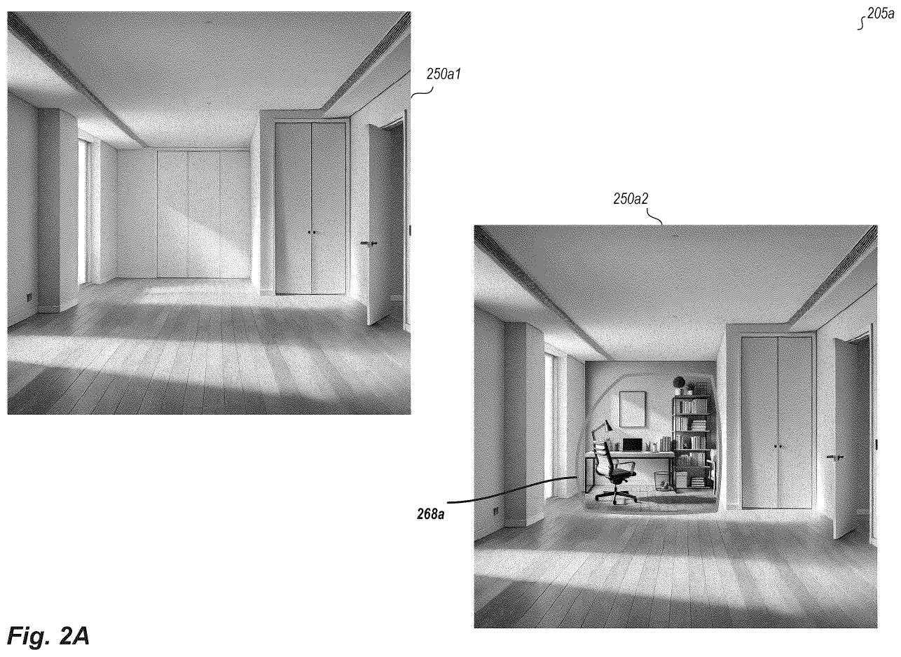

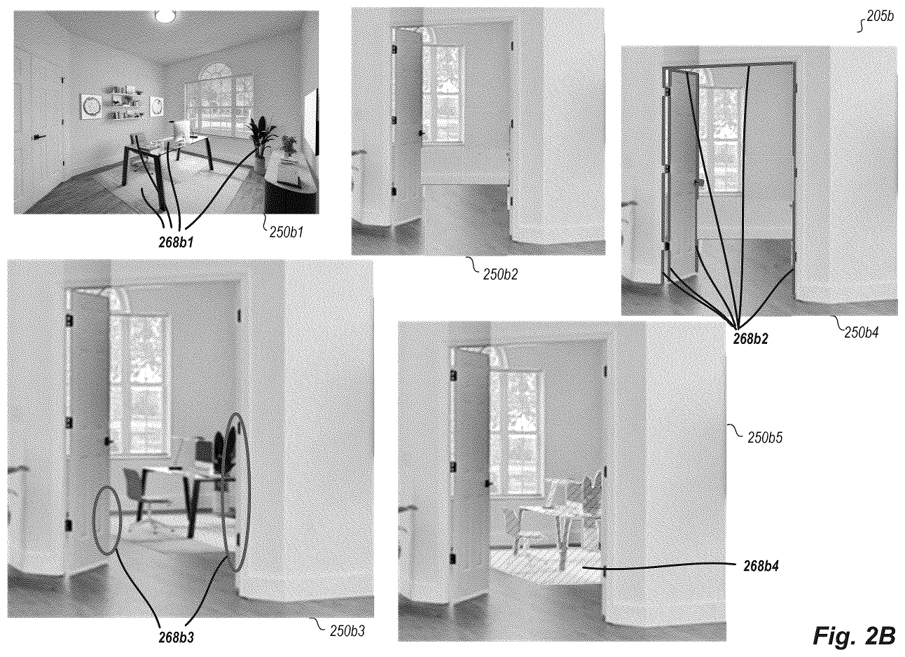

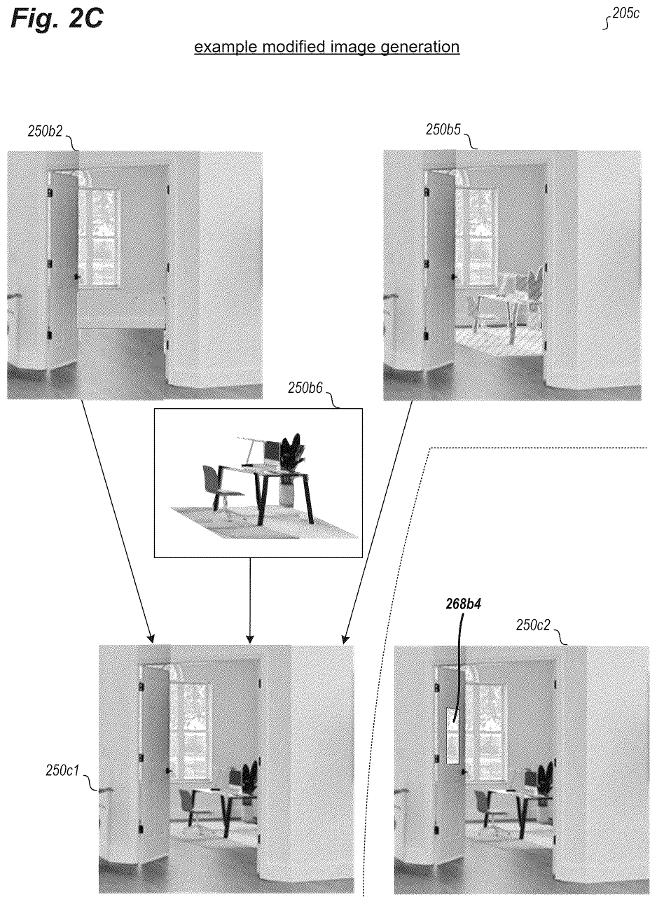

As noted above, the automated operations may include using multiple trained neural network models of multiple types as part of generating modified images. In at least some embodiments, the multiple trained neural network (NN) models of multiple types include a deep-learning depth discontinuity NN model trained to generate a depth discontinuity map for a dwelling image that identifies locations of adjacent or otherwise nearby pixels in the image having discontinuous differences in depth (from the image's acquisition location and orientation, or ‘pose’) corresponding to edge transitions from first surfaces visible in the dwelling image to other second surfaces (e.g., behind or in front of the first surfaces) in the source image, such as a non-convolutional deep-learning depth discontinuity NN model that uses an architecture other than a convolutional NN. The depth discontinuity map may, for example, include outlines of structural elements that provide such edge transitions, such as doorways, non-doorway wall openings, sides of objects that are not on walls such as kitchen islands, windows, etc. In some embodiments and situations, a depth discontinuity NN model may be trained to predict per-pixel depth values of an input image using visual data of the input image (whether depth or inverse depth values), and use those per-pixel depth values to identify pixels corresponding to the edge transitions (e.g., adjacent or otherwise nearby pixels having depth values that differ by more than a defined depth threshold). In some embodiments and situations, a depth discontinuity NN model may be trained to directly detect the edge transitions corresponding to occluding edges of overlapping surfaces from the image's pose, and use those detected edge transitions to identify the adjacent or otherwise nearby pixels corresponding to the edge transitions. In other embodiments and situations, a depth discontinuity map may be determined for a dwelling image in other manners that do not include using a trained NN model. As one non-exclusive example, a depth discontinuity map for a dwelling image may be inferred using an estimated camera pose for the dwelling image and estimated three-dimensional (3D) structural elements for a room visible in the dwelling image (e.g., walls, doorways, etc., such as from a 3D model of the room), such as by projecting the visible edges of the structural elements into the 2D coordinate system of the dwelling image at their actual locations using the camera pose, filtering edges of structural elements that do not produce a depth discontinuity from the camera pose, and producing a 2D depth discontinuity image for the dwelling image using the remaining edges that do produce depth discontinuities. As another non-exclusive example, in some embodiments and situations, actual depth data may be gathered from the acquisition location of a source image (by the camera device or other associated device, such as using LiDAR, structured light, etc.), and such actual depth data may be used in whole or in part (e.g., as supplemented with per-pixel predicted depth data for at least some pixels of the source image by a trained NN model) in generating a depth discontinuity map for the source image. Additional details are included herein regarding depth discontinuity maps and their generation, including with respect to image 250b2 of FIG. 2B.

As is also noted above, the automated operations for generating a modified version of a dwelling image may include adding a visual representation of a virtual object at a respective placement location within a room or other area shown in the dwelling image, with the dwelling image to be modified referred to as a ‘source image’ or ‘source dwelling image’ at times herein. As part of such adding of a visual representation of a virtual object to a placement location within a source image, the automated operations may include generating or otherwise obtaining a target image with a visual representation of the virtual object that is scaled and rotated to correspond to a size and orientation from the source image's acquisition pose—in at least some such embodiments, the target image of the virtual object is the same size as and with the same quantity of and arrangement of pixels as the source image (e.g., the same number of pixel rows and columns), with the visual representation of the virtual object being a subset of the pixels that are non-transparent and the other pixels that do not represent the visual representation of the virtual object being transparent, referred to at times herein as a ‘masked image’, and with the visual representation being further translated within the target masked image to be at the same position at which the virtual object's visual representation will appear within the modified source image, as well as scaled and rotated if need be. Such a target masked image with a visual representation of a virtual object that is scaled, rotated and translated may in at least some embodiments be generated from one or more preexisting masked images of the virtual object at different scales, rotations and/or translations, such as to modify such a preexisting masked image or otherwise use the one or more preexisting masked images to generate the target masked image (e.g., using a trained diffusion machine learning model)—in other embodiments, the target masked image may be generated in other manners, such as by generating a rendering from a 3D model of the virtual object. Non-exclusive examples of types of virtual objects that may be added to source dwelling images include movable objects (e.g., furniture, etc.) and/or non-movable objects such as structural elements (e.g., windows, doorways, non-doorway wall openings, walls, floors, ceilings, stairways, built-in structures such as fireplaces and kitchen islands and exposed beams, etc.) and other installed and/or fixed objects in dwelling rooms (e.g., installed fixtures, appliances, cabinets, switches and other controls, etc.) and/or within dwelling exteriors (e.g., on the dwelling exterior surface and/or on a surrounding property, such as porch swings, driveways, sidewalks, outbuildings, gardens and other plants and flora, etc.)—such installed and/or fixed objects may further include, for example, various types or categories of surfaces (e.g., types of floor coverings, such as tile or carpet or hardwood or laminate; types of wall coverings, such as paint or stucco or siding; types of roof coverings, such as shingles or metal or tile; other types of surface coverings, such as for kitchen islands or cabinets or vanities; etc.). While the remainder of the document will refer generally to “object” types, the “object” term as used herein is intended to include objects and other visible surfaces and elements unless otherwise indicated explicitly or by context. Additional details are included herein regarding target masked images, including with respect to image 250b5 of FIG. 2C.

In addition, a virtual object to be added and/or a source image to which it is added may be determined in various manners, such as by being selected (e.g., by a user who is requesting the modified image) from multiple candidate virtual objects or object types (e.g., from object images having associated 3D acquisition poses; from textual labels or descriptions of the objects, whether textual and/or spoken or otherwise verbal descriptions that are modified using speech-to-text recognition or otherwise supplied to a neural network model trained to interpret verbal descriptions; etc.) or from multiple candidate source dwelling images (e.g., images having associated 3D acquisition poses and being associated with existing dwellings at which they were captured, such as listing photos), respectively, that are provided by the ADIOM system, or alternatively in some embodiments may be supplied to the ADIOM system (e.g., by a user who is requesting the modified image). For an image supplied to the ADIOM system without associated metadata that includes 3D acquisition poses (or another existing dwelling or object image that lacks such 3D acquisition poses), the ADIOM system may further in some embodiments analyze the visual data of the image to determine such a 3D acquisition pose for the image and optionally other metadata. In addition, for embodiments in which a 3D room shape or other 3D dwelling model are used for determining a depth discontinuity map for a source image, if such data is not yet available for a room or other area visible in a source image, that source image and/or other dwelling images with visual data of that room or other area (e.g., exterior area, such as a patio or deck or other area outside a dwelling and on a property on which the dwelling is located) may similarly be analyzed to determine the 3D room shape or other 3D dwelling model, as discussed in greater detail elsewhere herein. Similarly, the placement location of a virtual object within a room or other area visible in a source image may be determined in various manners in various embodiments, including in some embodiments based on a user selection or specification (e.g., by a user who is requesting the modified image, such as by dragging or otherwise placing a visual representation of the virtual object within the source image), and in other embodiments based on an automated analysis of the source image and/or virtual object (e.g., by a trained diffusion machine learning model or other machine learning model).

In at least some embodiments, the multiple trained NN models of multiple types further include a convolutional NN (“CNN”) or other type of NN that is trained to use a depth discontinuity map for a source dwelling image showing a room to generate an occlusion mask for the source image, with the occlusion mask indicating per-pixel determinations of which of multiple sources to use for that pixel's value in a modified version of the source image in which one or more virtual objects are added (e.g., from the original source image, such as if a virtual object is not placed as the location of that pixel or if the pixel location is part of an occluding surface that blocks visibility of part of a virtual object that would otherwise be visible at that pixel location, or from a target masked image of a virtual object being added if the pixel location corresponds to a part of a virtual object that is being added and is not occluded by any intervening surfaces). Alternatively, if some embodiments and situations an occlusion mask may not be generated and used, such as if an analysis of the depth discontinuity mask and the placement location(s) of the virtual object(s) being added indicate that the placement location(s) do not overlap with any of the depth discontinuity lines (or is not within a defined pixel distance threshold of any depth discontinuity lines, such as 5 pixels or 10 pixels or 20 pixels or 30 pixels), to reflect that subsets of the virtual objects are not occluded by intervening surfaces—in such embodiments, the target masked image(s) of the virtual object(s) may be directly overlaid on the source image. Additional details are included herein regarding such occlusion masks, including with respect to image 250b4 of FIGS. 2B and 2C.

The described automated techniques provide various benefits in various embodiments, including to significantly improve the ability to visualize structural changes in dwelling images based on corresponding added virtual objects in resulting modified images to add or modify visual structural elements, as well as to use identified dwelling-object information in various manners (e.g., in response to specified queries for information about dwellings satisfying one or more specified criteria, including queries specified in a natural language format), and to significantly improve functionality for controlling the generation of modified images for associated dwellings in particular specified manners. Such automated techniques also allow such modified images to be generated more efficiently (e.g., using less storage and/or memory and/or computing cycles) and with greater accuracy, based at least in part on using the multiple trained neural network models of multiple types in particular manners as described herein (e.g., in a particular order, and to perform specified actions). In addition, in some embodiments the described techniques may be used to provide an improved GUI (graphical user interface) in which a user may more accurately and quickly obtain real estate-related information, including in response to an explicit request (e.g., in the form of a natural language query), as part of providing personalized information to the user, etc. Various other benefits are also provided by the described techniques, some of which are further described elsewhere herein.

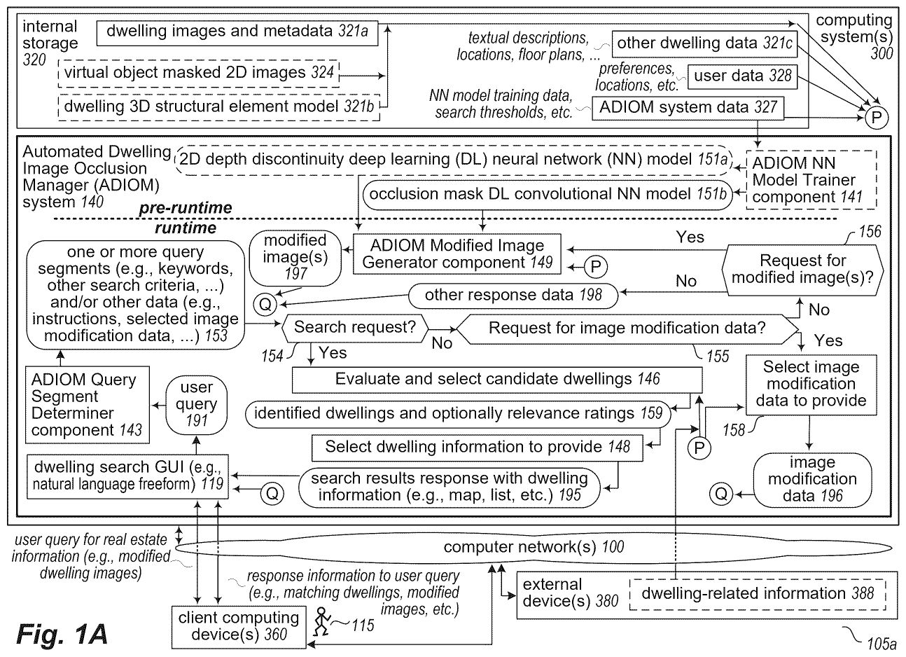

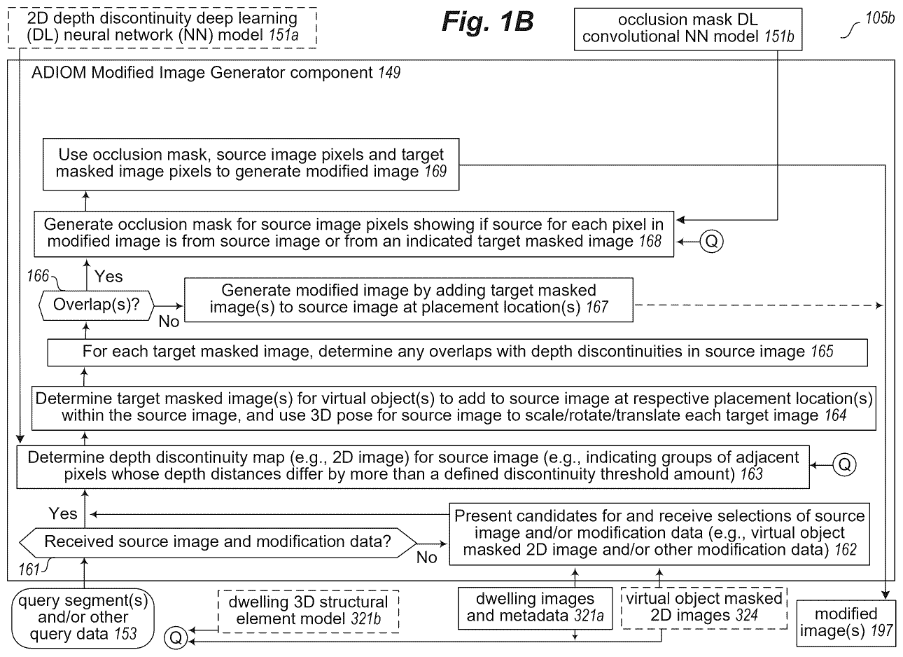

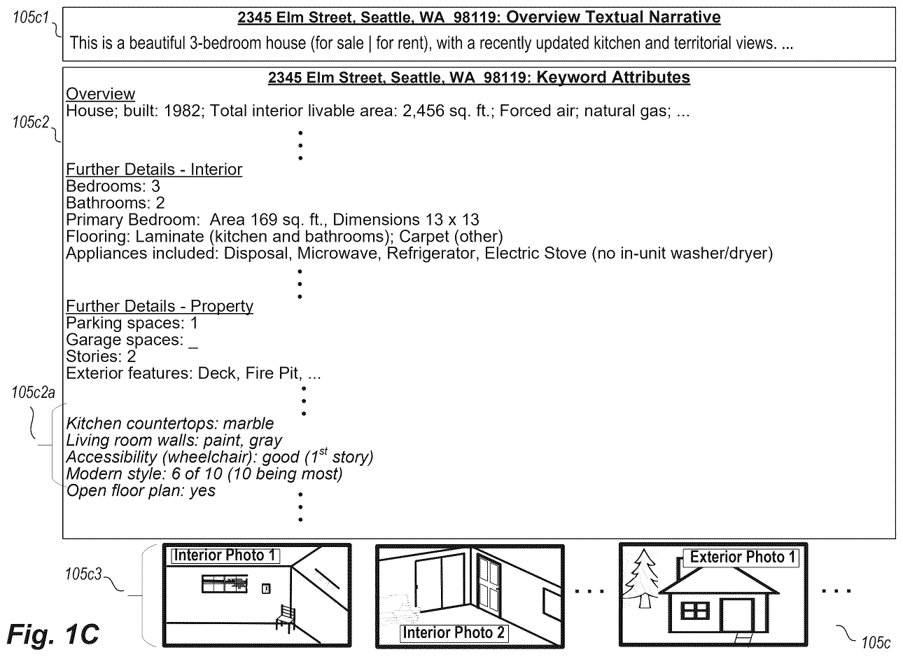

FIGS. 1A-1B are network diagrams illustrating an example system for performing described techniques, including automatically generating and using modified dwelling images based on multiple trained neural network models of multiple types.

In particular, FIG. 1A illustrates information 105a about an example embodiment of an ADIOM system 140 executing on one or more computing systems 300, and interacting over one or more computer networks 100 with one or more client computing devices 360, such as to receive query requests from users 115 of the client computing devices for information about dwellings and to provide corresponding responses with requested dwelling information (e.g., as part of search results), as well as to receive instructions regarding generating new modified images. In the illustrated embodiment, the computing systems 300 may store various information on storage 320 that is used by the ADIOM system during operation (e.g., in one or more databases), including dwelling data 321 about dwellings in one or more geographical areas (e.g., in one or more countries, states, cities, etc., such as dwelling images 321a and associated metadata such as 3D acquisition poses of the images, 3D dwelling models 321b showing room shapes with structural elements, and other dwelling information 321c including information about objects identified in dwellings from analysis of dwelling images as well as other information such as textual building descriptions of the dwellings), user data 328 (e.g., user location; user preferences, such as expressly specified and/or implicitly determined from past activities of the user such as viewing or otherwise interacting with information about dwellings; prior and/or concurrent search interaction sessions with the user; etc.), and ADIOM system data 327 (e.g., training data for depth discontinuity NN models and/or occlusion mask NN models, search comparison thresholds, distance thresholds between virtual object placement locations and depth discontinuity lines, predefined keywords, information for use in segment determination such as word-break and/or phrase-break vocabularies, etc.). The ADIOM system may further optionally retrieve and use other dwelling-related information 388 of one or more types stored externally to the computing systems 300 (e.g., from one or more public and/or private information sources), such as accessed over the one or more computer networks 100 from one or more external computing and/or storage devices 380, whether in addition to or instead of information stored on storage 320.

As one example of operations of the ADIOM system 140, an ADIOM NN Model Trainer component 141 may optionally obtain NN model training data from the ADIOM system data 327 (e.g., dwelling-specific depth discontinuity map data examples, such as positive and/or negative examples; dwelling-specific occlusion mask data examples, such as positive and/or negative examples; etc.), and generate one or more resulting trained NN models 151 (e.g., 151a, 151b) for subsequent use (e.g., a trained depth discontinuity NN model 151a, such as one trained in a dwelling-specific manner to generate 2D depth discontinuity maps for images of rooms and/or other areas in and around dwellings; a trained occlusion mask CNN model 151b, such as one trained in a dwelling-specific manner to generate occlusion masks for images of rooms and/or other areas in and around dwellings; etc.). In other embodiments, a pretrained depth discontinuity NN model 151a and/or a pretrained occlusion mask CNN model 151b may be used, whether pretrained in a manner specific to dwellings or not. The ADIOM system 140 then uses the multiple trained NN models 151 as part of generating modified images, including in response to received user instructions, as described further below.

During further operations of the ADIOM system 140, a particular user 115 of one of the client computing devices 360 may supply a query 191 about one or more dwellings to a GUI 119 provided by the ADIOM system (e.g., as natural language free-form input). The GUI provides the user query to an ADIOM Query Segment Determiner component 143, which analyzes the user query to attempt to identify segments within the query corresponding to one or more search criteria or to other instructions or data, such as to optionally include indications of instructions and/or associated input data for use in generating a modified image, as well as to optionally include other types of search criteria (e.g., keyword-based query segments, additional query segments that do not include any predefined keywords, etc.)—if the component 143 is unable to identify such segments or other data, such as due to the received query lacking a correct format or types of information or due to having other problems, the component instead may generate and return a clarifying query response (not shown) to the GUI 119 to request further information from the user and/or to indicate an inability to respond. Otherwise, the system 140 determines in block 154 if the data 153 from the user query 191 is part of a search request, and if so uses the determined query segments and/or other data 153, along with user data 328, dwelling data 321 and optionally types of ADIOM system data 327 other than training data (e.g., search comparison thresholds), to evaluate and select candidate dwellings and to select identified dwellings 159 that match the search criteria of the user query 191, optionally along with relevance ratings for some or all of the identified dwellings. The identified dwellings 159 are then used to select and generate information 148 specific to the identified dwellings to include as part of a search results response with target dwelling information 195, such as to filter and/or rank the identified dwellings (e.g., based on the relevance ratings), to select types of information to include for a dwelling, to format the search results in a particular manner (e.g., in a list format or overlaid on a map), etc. After the query response 195 with the dwelling information is generated, or if the component 143 instead generates a clarifying query response without forwarding the query segments 153 to the component 146, the generated query response 195 or clarifying query response is provided via the GUI 119 to the client computing device of the user who submitted the query, such as for display on the client computing device as part of the GUI.

If the system 140 instead determines in block 154 that the data 153 from the user query 191 is not part of a search request, the system determines in block 155 if the user query 191 includes a request to receive information for image modification data, such as to provide options for generating a modified image (e.g., one or more source dwelling images from which to generate a modified image, optionally with one or more preselected virtual objects that are available to be added, and/or optionally for one or more specific indicated dwellings; one or more types of objects to add to a modified image, optionally with one or more source dwelling images that are of a type to include an object of the object type(s), and/or optionally for one or more specific indicated dwellings; etc.). If so, the system 140 in block 158 selects corresponding image modification data 196 to provide, such as using dwelling data 321 and/or user data 328 and/or ADIOM system data 327, and proceeds to provide that data 196 via the GUI 119 to the client computing device of the user who submitted the query, such as for display on the client computing device as part of the GUI.

If the system 140 instead determines in block 155 that the data 153 from the user query 191 is not part of a request for image modification data, the system determines in block 156 if the user query 191 includes a request to generate a modified image based on associated instructions that are provided, and if not generates other response data 198. Otherwise, the system 140 proceeds to perform the ADIOM Modified Image Generator component 149 to generate one or more such modified images 197, including using the data supplied in the user query and optionally dwelling data 321 and/or user data 328 and/or ADIOM system data 327 to do so—FIG. 1B provides one example of automated operations of such a component 149. The system then proceeds to provide the modified image(s) 197 or other response data 198 via the GUI 119 to the client computing device of the user who submitted the query, such as for display on the client computing device as part of the GUI.

The same user may then provide one or more subsequent queries 191 to the GUI 119 as part of an ongoing interaction session, such as with similar processing performed for the subsequent user queries, and optionally with the context of prior interactions during the session being maintained and used by the ADIOM system (e.g., stored and used to add missing information in later queries, such as dwelling type or geographical area; stored and used to personalize responses generated for such subsequent queries, etc.). In addition, a user may in some embodiments and situations provide optional user feedback (not shown), such as to indicate that incorrect search criteria have been determined for the user query, to otherwise provide feedback regarding accuracy of search results response 195 or other response data 196, 197 and/or 198 or to provide further clarifying information in response to a clarifying query response, to specify further user preferences to be used, etc. If so, such optional user feedback may be forwarded to some or all of the system 140 components, such as to improve future determinations performed by the components. In other embodiments and situations, some or all such feedback may instead be implicit feedback that is determined based on an analysis of subsequent user queries (e.g., to indicate that a prior query response did not provide information that the user was seeking) and/or of prior user queries (e.g., to determine user preferences and/or user location, such as based on patterns in the prior user queries). While the example discussed above involves a single user performing multiple interactions with the ADIOM system as part of an interaction session (e.g., spanning seconds, minutes, hours, days, etc.), it will be appreciated that the ADIOM system may in at least some embodiments and situations be concurrently interacting with many users using different client computing devices, such as to maintain separate GUIs and interaction session histories for such users, and that a new interaction session may be initiated for a user after one or more prior interaction sessions with that user in various manners (e.g., based on a corresponding user instruction, such as to reflect a change in the types of dwelling information of interest; as determined automatically by the ADIOM system, such as to reflect a change in the types of dwelling information being requested, or due to a defined period of time since a last user interaction being exceeded, such as one or more days; etc.).

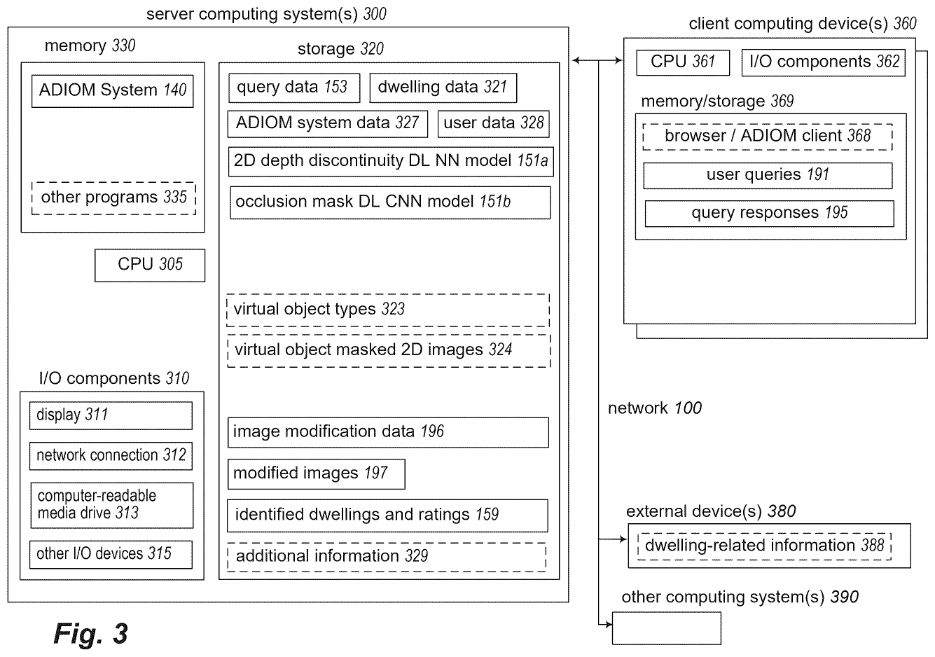

In addition, the computing system(s) 300 may include various other components and functionality, as discussed in greater detail elsewhere herein, including with respect to FIG. 3. The computer networks 100 may similarly be of various types in various embodiments and may include various types of wired and/or wireless segments, including one or more publicly accessible linked networks (e.g., operated by various distinct parties, such as the Internet) and/or a private network (e.g., a corporate or university network that is wholly or partially inaccessible to non-privileged users), including in some cases to have both private and public networks (e.g., with one or more of the private networks having access to and/or from one or more of the public networks).

FIG. 1B continues the example of FIG. 1A, and illustrates information 105b for one example embodiment of the ADIOM Modified Image Generator component 149 discussed in FIG. 1A. In particular, the component 149 performs various activities in the illustrated embodiment to generate and provide one or more such modified images 197, including using data supplied in the user query and optionally additional dwelling data 321 and/or user data 328 and/or ADIOM system data 327 to do so.

In operation, the component 149 receives, as input, data 153 from the received user query, which may include instructions related to generating one or more modified images (e.g., for use in controlling the modifications performed), and optionally additional image modification data (e.g., a source image to be modified, and/or information about one or more virtual objects to be added as part of modifying the source image, optionally along with an indicated placement location for a virtual object within a room or other area visible in the source image, etc.)—in at least some embodiments and situations, some or all of the input data 153 may be included based on selections previously made by a user from candidate options provided to the user in a GUI. In block 161, the component determines if the data received from the user query includes a source image and sufficient image modification data to specify how to modify the source image to generate one or more resulting modified images (e.g., data for multiple defined types, such as which one or more virtual objects to add to the source image, an indicated placement location for such a virtual object, etc.), and if so proceeds to block 163. Otherwise, the component continues to block 162, where it determines and presents candidates to the user for a source image (if not already specified) and/or for other image modification data of one or more types (if not already specified), and receives corresponding selections from the user (e.g., using dwelling images 321a; a list of virtual object types and/or associated object images, such as corresponding to objects typically visible in dwelling images or more generally associated with particular dwelling rooms or other areas; etc.), and then proceeds to block 163. In block 163, the routine then determines a depth discontinuity map (e.g., a 2D image) for the source image, such as with discontinuity lines corresponding to groups of adjacent pixels whose depth distances differ by more than a defined discontinuity threshold amount. In block 164, the routine then determines one or more target masked images to add to the source image at one or more respective placement locations within the source image (e.g., as specified in blocks 153 or 162, by retrieving and/or generating target masked images for one or more objects or object types indicated in blocks 153 or 162, etc.), and uses 3D pose data for the source image to scale/rotate/translate the virtual object's visual representation in a target masked image as needed. In block 165, for a target masked image, the component determines if it overlaps (e.g., within any defined distance threshold) with any depth discontinuities in the source image. In block 166, the component determines if any such overlaps exist, and if not, proceeds to block 167 to generate a modified image by adding the target masked image(s) to the source image at the respective placement location(s). Otherwise, in block 168, the block generates an occlusion mask for the source image's pixels showing if the source for respective pixels in the modified image is to come from the source image or from an indicated target masked image. In block 169, the block then uses the occlusion mask, source image's pixels and pixels of the target masked image(s) to generate the modified image. After blocks 167 or 169, the modified image is then provided in block 197.

FIG. 1C illustrates examples of non-exclusive types of dwelling description information 105c that may be available in some embodiments for an example dwelling (in this example, a house available for rental and/or purchase), such as existing building information that is optionally supplemented by the ADIOM system with data identified from image analysis, and that is subsequently analyzed and used by the ADIOM system (e.g., in responding to search and browse query requests). In the example of FIG. 1C, the dwelling description information 105c includes an overview textual narrative description 105c1, various keyword attribute data 105c2, and various associated images or other digital media items or content pieces 105c3, such as may be used in part or in whole as listing information for an NNS (multiple listing service) system. In this example, the attribute data is grouped into sections (e.g., overview attributes, further interior detail attributes, further property detail attributes, etc.), with most of the attribute data specified using keyword-value pairs having a keyword and at least one corresponding value (although other attributes may be specified using a keyword without any associated values, such as based on the presence or absence of a keyword such as “deck” or “pool”)—in other embodiments, the attribute data may not be grouped or may be grouped in other manners and may be specified in other manners, including for the dwelling description information to not be separated into a list of attributes and a separate overview textual narrative description. In this example, the separate overview textual narrative description emphasizes characteristics that may be of interest to viewers, such as a dwelling style type, information of interest about rooms and other dwelling characteristics (e.g., have been recently updated or have other characteristics of interest), information of interest about the property and surrounding neighborhood or other environment, etc. In addition, in this example, the attribute data includes objective attributes of a variety of types about rooms and the dwelling and limited information about appliances or other objects, but may initially lack details of various types shown in italics in this example for attributes 105c2a, including for objects subsequently identified for dwellings from image analysis (e.g., the type of kitchen countertops, the types of wall coverings in rooms such as the living room, etc.) and optionally for other data identified via image analysis (e.g., about subjective attributes, such as having an open floor plan, being accessible, having a type of style, etc. ; about inter-room connectivity and other adjacency; etc.), such as may instead be determined by the ADIOM system via analysis of dwelling images and/or other building information (e.g., floor plans), and/or may lack details of various types shown in italics in this example for attributes 105c2a (e.g., about subjective attributes; about attributes associated with rental usage policies, such as if the dwelling is only available for acquisition; etc.). In addition, in this example, the digital media items or other content pieces 105c3 include multiple dwelling images (both inside and outside in this example), but do not include various other types of digital media items that may be present in some embodiments for at least some dwellings (e.g., a 2D floor plan, a 3D computer model floor plan, audio clips, video clips, a virtual tour of inter-linked images through which a viewer may progress in a user-selected and/or automated manner, etc.).

It will be appreciated that various details are provided with respect to FIGS. 1A-1C for illustrative purposes, and are not intended to limit the scope of the invention unless otherwise indicated. Similarly, additional exemplary details are provided with respect to FIGS. 2A-2C and elsewhere herein, and such details are similarly provided for illustrative purposes and are not intended to limit the scope of the invention unless otherwise indicated.

As noted above, the source image to be modified and/or various types of modification data to use in its modification may be specified in various manners in various embodiments. For example, in at least some embodiments, the ADIOM system may store various dwelling images for dwellings, and may use some or all of those dwelling images as possible source images to be modified, including in at least some such embodiments to determine a subset of the dwelling images to be used as modifiable source images in one or more manners (e.g., based on showing visual data for particular types of rooms; based on including particular types of objects in their visual data; based on meeting other criteria, such as with respect to clarity and/or visual coverage of a room or other area; etc.), such as based on automated analysis of the dwelling images and/or based on user selection of particular dwelling images to use. In other embodiments and situations, at least some source images that are modified may instead be supplied by a user who is interacting with the ADIOM system. In situations in which the ADIOM system uses some or all of its dwelling images as possible source images to be modified, the system may further provide some or all such images to the user for selection, such as for display to the user. In a similar manner, the ADIOM system may store information about one or more types of modification data that may be used to modify source images, and may similarly present some or all such modification data type information to the user for selection. For example, such types of modification data may include lists of and/or images of object types that may be added, etc. In other embodiments and situations, at least some types of modification data that is used for modified source images may instead be supplied by a user who is interacting with the ADIOM system. In addition to receiving user indications of or other automated determinations of a particular source image and image modification data to use, the ADIOM system may in some embodiments and situations receive instructions or other indications from a user of modification data use. Additional details are included below regarding performing modifications to particular objects in source images to generate resulting modified images, including with respect to the examples of FIGS. 2A-2C.

In addition, in at least some embodiments, some or all search queries may be entered using multiple free-form natural language terms to specify one or more search criteria, and if so the ADIOM system may analyze such a query to determine the user-specified criteria to use, including by segmenting the terms in the received query into one or more segments corresponding to one or more indicated search criterions. Such segmenting of the sequence of term(s) may be performed in various manners in various embodiments, including to identify one or more segments for one or more search criteria of one or more specific types, such as one or more of the following: dwelling-type designations (e.g., ‘apartment’, ‘single family house’, ‘condominium’, etc.); POI categories (e.g., “beaches”, “parks”, “schools”, “hospitals”, “lakes”, etc.); indeterminate distance indications that are associated with one or more POI locations and/or POI categories (e.g., “nearby” or analogous terms such as “near”, “by”, “around”, “at”, “close to”, “adjacent”, etc. ; a travel-based distance measure with an indicated travel type, such as walking or bicycling or scootering or driving or bus or train or light rail or mass transit; etc., and an associated amount of travel time that is specified or otherwise determined); non-location-related search filters or other search criteria, such as search criteria related to dwelling attributes (e.g., minimum and/or maximum and/or target price, number of bathrooms, number of bedrooms, etc.), etc. Additional details are included herein related to analyzing a sequence of one or more terms of a received query that is specified using free-form natural language.

For illustrative purposes, some embodiments are described herein in which specific types of information are acquired, used and/or presented in specific ways using specific types of data structures and by using specific types of devices—however, it will be understood that the described techniques may be used in other manners in other embodiments, and that the invention is not limited to exemplary details provided. As one non-exclusive example, specific types of data structures and algorithms are generated and/or used in specific manners in some embodiments, but it will be appreciated that other types of information may be generated and used in other manners in other embodiments, including for types of information other than dwelling information. Similarly, while particular user interface display and interaction techniques are shown, other user interaction techniques may be used in other embodiments. In addition, the term “dwelling” refers herein to any partially or fully enclosed structure in which one or more humans may reside at least some of the time and in which other types of activities may optionally be performed, typically but not necessarily encompassing one or more rooms that visually or otherwise divide the interior space of the structure—non-limiting examples of such dwellings include houses, apartment buildings or individual apartments therein, condominiums, supplemental structures on a property with another main building (e.g., a detached accessory dwelling unit), live-work spaces, etc. The term “acquire” or “capture” as used herein with reference to a dwelling interior or exterior, acquisition location, or other location (unless context clearly indicates otherwise) may refer to any recording, storage, or logging of media, sensor data, and/or other information related to spatial characteristics and/or visual characteristics and/or otherwise perceivable characteristics, such as by a recording device or by another device that receives information from the recording device. In addition, various details are provided in the drawings and text for exemplary purposes, but are not intended to limit the scope of the invention—for example, sizes and relative positions of elements in the drawings are not necessarily drawn to scale, with some details omitted and/or provided with greater prominence (e.g., via size and positioning) to modify legibility and/or clarity, and identical reference numbers may be used in the drawings to identify the same or similar elements or acts.

FIGS. 2A-2C illustrate examples of performing described techniques, including automatically generating and using modified dwelling images based on multiple trained neural network models of multiple types.

In particular, FIG. 2A illustrates information 205a showing one example of an image 250a1 that may be used as a source dwelling image (in this example, of an empty bedroom), and a resulting modified image 250a2 in which a number of virtual objects 268a have been added to the source image (e.g., a desk, chair, picture on the wall, light on the desk, bookshelf, wastebasket, etc.). In this example, there are no intervening structural elements or other objects or surfaces between the acquisition pose of the camera that captured the source image and the placement locations in which the virtual objects are added-accordingly, one or more target masked images (not shown) for the virtual objects being added may be overlaid on the source image without use of an occlusion mask as discussed elsewhere herein.

FIG. 2B continues the example of FIG. 2A, and shows information 205b that includes another example image 250b1, which in this example is a modified image in which similar virtual objects 286b1 have been added to a source image (not shown) of a home office (e.g., a rug, desk, chair, computer, planted pot, etc.). In the same manner as modified image 250a2 of FIG. 2A, there are no intervening structural elements or other objects or surfaces between the acquisition pose of the camera to capture the source image and the placement locations in which the virtual objects are added—however, in the example of image 250b1, the placement location for the rug causes only a portion of the rug to fit within the modified image 250a2. Image 250b2 of FIG. 2B illustrates an example of a different source image in which the same virtual objects are added to the same room at the same placement locations, but in a more complex situation in which the source image is captured at an acquisition pose outside of the home office room, with portions of the home office room being visible through open doors of the room. In this example, some of the portions of the virtual objects shown in image 250b1 will no longer be visible in the resulting modified image, with image 250b3 illustrating an example of such a modified image in which the edges of the doors 268b3 block views of parts of at least the rug and desk virtual objects.

Accordingly, using the described techniques, image 250b4 illustrates an example of a depth discontinuity map that may be generated for the source image 250b2, and in particular to include discontinuity lines 268b2 showing edges of overlapping surfaces where adjacent or otherwise nearby pixels have differences in predicted or determined depth that are greater than a defined depth threshold—in this example, the depth discontinuity lines include the outline of the doorway, and the outline of one of the two visible open doors. Image 250b5 of FIG. 2B continues the example, and illustrates an example occlusion mask that may be generated in preparation for generating the modified image (similar to image 250b3 without the red areas 268b3 being shown)—in particular, the yellow areas 268b4 of the occlusion mask indicate where pixels of the modified image will come from one or more target masked images (not shown) of the virtual objects, while other areas of the occlusion mask indicate pixels whose values will come from the original source image 250b2. It will be appreciated that, while the target masked image(s) for the virtual object(s) may show all of the desk and some or all of the portions of the rug that are visible in image 250b1, the occlusion mask does not indicate to include pixels from the masked target image(s) that correspond to those portions of the rug and desk that are blocked by the door and doorway as outlined in the depth discontinuity map of image 250b4.

FIG. 2C continues the examples of FIGS. 2A-2B, and illustrates information 205c that provides an example of generating a modified image 250c1 based on a specified source image 250b2 and specified image modification data that indicates the virtual objects to be added. In particular, in this example, source image 250b2 has been selected (e.g., by a user, not shown) to be used as the source image (e.g., from multiple presented candidate source images, not shown), and the user further specifies image modification data of one or more types about the virtual objects to be added, with a masked target image 250b6 showing a combination of the multiple virtual objects (in other embodiments and situations, a virtual object may have a separate target masked image that are combined together in creating the modified image). The source image 250b2 and target masked image 250b6 for the selected or otherwise specified virtual objects are then used in this example, together with the occlusion mask 250b5, to generate modified image 250c1 by modifying the source image to include the visible portions of the virtual objects within the home office room through the open doorway in the manner discussed herein, including by using multiple trained NN models (not shown) of multiple types.

FIG. 2C further illustrates a different modified image 250c2 that may be generated from the same source image 250b2 in some embodiments and situations, but in which the virtual object(s) that are added include a transparent object 268b4 (e.g., glass or a hole), such as to simulate replacing the existing door with an alternative one having a glass window in the upper portion of the door. Since the occlusion mask (not shown) for such a modification of the source image will indicate that the pixels behind the glass window or hole (from the perspective of the source image's acquisition pose) do not come from the source image, the visual data for those pixels in the modified image may be generated in a different manner, such as by using corresponding portions of the source image for modified image 250b1 that are reprojected into the modified image 250c2 from the acquisition pose of the source image 250b2, or alternatively in other manners (e.g., using a trained diffusion model, not shown, to inpaint those portions of the home office room that will be visible through the glass window or hole). It will be appreciated that other types of source images may be modified for other types of virtual objects in other manners in other embodiments.

It will also be appreciated that the examples of FIGS. 2A-2C are provided for illustrative reasons only, and are not intended to limit the scope of the invention. For example, a variety of other combinations of natural language free-form search terms may be used in other embodiments and situations.

In addition, further details related to at least some operations of the ADIOM system and its components, including with respect to analyzing images and to analyzing and responding to search queries, are included in U.S. Non-Provisional patent application Ser. No. 18/583,602, filed Feb. 21, 2024 and entitled “Automated Tool For Determining And Providing Building Information For Multiple Partially Described Proximate Geographical Regions”; in U.S. Non-Provisional patent application Ser. No. 18/642,246, filed Apr. 22, 2024 and entitled “Automated Tool For Determining And Using User-Specific Predicted Attributes Of Dwellings That Users Will Later Occupy”; in U.S. Non-Provisional patent application Ser. No. 18/734,815, filed Jun. 5, 2024 and entitled “Automated Tool For Determining And Providing Information About Dwellings Satisfying Search Criteria Specified Using Multiple Data Modes”; in U.S. Non-Provisional patent application Ser. No. 18/622,829, filed Mar. 29, 2024 and entitled “Automated Tool For Determining And Providing Information About Dwellings Within Geographical Regions That Are Determined Specific To Indicated Locations”; and in U.S. Non-Provisional patent application Ser. No. 18/632,217, filed Apr. 10, 2024 and entitled “Automated Tool For Determining And Providing Information About Dwellings Using Heterogenous Search Strategies”; all of which are incorporated herein by reference in its entirety.

Also, additional details related to at least some operations of the ADIOM system and its components, including with respect to analyzing images and other data about buildings and other dwellings, are included in U.S. Non-Provisional patent application Ser. No. 16/693,286, filed Nov. 23, 2019 and entitled “Connecting And Using Building Data Acquired From Mobile Devices” (which includes disclosure of an example BICA system that is generally directed to obtaining and using panorama images from within one or more buildings or other structures); in U.S. Non-Provisional patent application Ser. No. 16/236,187, filed Dec. 28, 2018 and entitled “Automated Control Of Image Acquisition Via Use Of Acquisition Device Sensors” (which includes disclosure of an example ICA system that is generally directed to obtaining and using panorama images from within one or more buildings or other structures); and in U.S. Non-Provisional patent application Ser. No. 16/190,162, filed Nov. 14, 2018 and entitled “Automated Mapping Information Generation From Inter-Connected Images”; in U.S. Non-Provisional patent application Ser. No. 16/681,787, filed Nov. 12, 2019 and entitled “Presenting Integrated Building Information Using Three-Dimensional Building Models” (which includes disclosure of an example FMGM system that is generally directed to automated operations for displaying a floor map or other floor plan of a building and associated information); in U.S. Non-Provisional patent application Ser. No. 16/841,581, filed Apr. 6, 2020 and entitled “Providing Simulated Lighting Information For Three-Dimensional Building Models” (which includes disclosure of an example FMGM system that is generally directed to automated operations for displaying a floor map or other floor plan of a building and associated information); in U.S. Non-Provisional patent application Ser. No. 17/080,604, filed Oct. 26, 2020 and entitled “Generating Floor Maps For Buildings From Automated Analysis Of Visual Data From The Buildings'Interiors”; in U.S. Non-Provisional patent application Ser. No. 16/807,135, filed Mar. 2, 2020 and entitled “Automated Tools For Generating Mapping Information For Buildings” (which includes disclosure of an example MIGM system that is generally directed to automated operations for generating a floor map or other floor plan of a building using images acquired in and around the building); in U.S. Non-Provisional patent application Ser. No. 15/950,881, filed Apr. 11, 2018 and entitled “Presenting Image Transition Sequences Between Acquisition Locations”; and in U.S. Non-Provisional patent application Ser. No. 17/013,323, filed Sep. 4, 2020 and entitled “Automated Analysis Of Image Contents To Determine The Acquisition Location Of The Image” (which includes disclosure of an example MIGM system that is generally directed to automated operations for generating a floor map or other floor plan of a building using images acquired in and around the building, and an example ILMM system for determining the acquisition location of an image on a floor plan based at least in part on an analysis of the image's contents); all of which are incorporated herein by reference in its entirety

FIG. 3 is a block diagram illustrating an embodiment of one or more server computing systems 300 executing an implementation of an ADIOM system 140, such as in a manner similar to that of FIGS. 1A-1B and with additional hardware details illustrated—the server computing system(s) and ADIOM system may be implemented using a plurality of hardware components that form electronic circuits suitable for and configured to, when in combined operation, perform at least some of the techniques described herein. In the illustrated embodiment, a server computing system 300 includes one or more hardware central processing units (“CPU”) or other hardware processors 305, various input/output (“I/O”) components 310, storage 320, and memory 330, with the illustrated I/O components including a display 311, a network connection 312, a computer-readable media drive 313, and other I/O devices 315 (e.g., keyboards, mice or other pointing devices, microphones, speakers, GPS receivers, etc.).

The server computing system(s) 300 and executing ADIOM system 140 may communicate with other computing systems and devices via one or more networks 100 (e.g., the Internet, one or more cellular telephone networks, etc.), such as user client computing devices 360 (e.g., used to supply queries; receive responsive answers; and use the received answer information, such as to display or otherwise present modified images or other answer information to users of the client computing devices and/or to implement further automated activities, such as to access other functionality provided by the ADIOM system), optionally other external devices 380 (e.g., used to store and provide dwelling information of one or more types), and optionally other computing systems 390.

In the illustrated embodiment, an embodiment of the ADIOM system 140 executes in memory 330 in order to perform at least some of the described techniques, such as by using the processor(s) 305 to execute software instructions of the system 140 in a manner that configures the processor(s) 305 and computing system 300 to perform automated operations that implement those described techniques. The illustrated embodiment of the ADIOM system may include one or more components, not shown, to respectively perform portions of the functionality of the ADIOM system, and the memory may further optionally execute one or more other programs 335. The ADIOM system 140 may further, during its operation, store and/or retrieve various types of data on storage 320 (e.g., in one or more databases or other data structures), such as various types of user data 328, dwelling data 321 (e.g., dwelling images; textual dwelling description data; 3D dwelling models and/or 3D dwelling shapes for rooms or other areas, object data, including as determined from analysis of visual data of dwelling images; etc.), ADIOM system data 327, trained depth discontinuity NN model 151a, trained occlusion mask CNN model 151b, virtual object type data 323, virtual object masked images 324, specified image modification data 196, generated modified images 197, identified target dwellings and optionally associated ratings 159, and/or various other types of optional additional information 329.

Some or all of the user client computing devices 360 (e.g., mobile devices), external devices 380, and other computing systems 390 may similarly include some or all of the same types of hardware components illustrated for server computing system 300. As one non-limiting example, the computing devices 360 are shown to include one or more hardware CPU(s) 361, I/O components 362, and memory and/or storage 369, with a browser and/or ADIOM client program 368 optionally executing in memory to interact with the ADIOM system 140 and present or otherwise use query responses 195 (e.g., generated modified images to be presented, candidate source images and/or other candidate image modification data to select from to be used as part of modified image generation, etc.) that are received from the ADIOM system for submitted user queries 191. While particular components are not illustrated for the other devices/systems 380 and 390, it will be appreciated that they may include similar and/or additional components.

It will also be appreciated that computing system 300 and the other systems and devices included within FIG. 3 are merely illustrative and are not intended to limit the scope of the present invention. The systems and/or devices may instead include multiple interacting computing systems or devices, and may be connected to other devices that are not specifically illustrated, including via Bluetooth communication or other direct communication, through one or more networks such as the Internet, via the Web, or via one or more private networks (e.g., mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, wearable devices, digital music player devices, handheld gaming devices, PDAs, wireless phones, Internet appliances, and various other consumer products that include appropriate communication capabilities. In addition, the functionality provided by the illustrated ADIOM system 140 may in some embodiments be distributed in various components, some of the described functionality of the ADIOM system 140 may not be provided, and/or other additional functionality may be provided.

It will also be appreciated that, while various items are illustrated as being stored in memory or on storage while being used, these items or portions of them may be transferred between memory and other storage devices, such as for purposes of execution, memory management, data integrity, etc. Alternatively, in other embodiments some or all of the software components and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., by the ADIOM system 140 executing on server computing systems 300) and/or data structures, such as by execution of software instructions of the one or more software programs and/or by storage of such software instructions and/or data structures, and such as to perform algorithms as described in the flow charts and other disclosure herein. Furthermore, in some embodiments, some or all of the systems and/or components may be implemented or provided in other manners, such as by consisting of one or more means that are implemented partially or fully in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the components, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, components and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

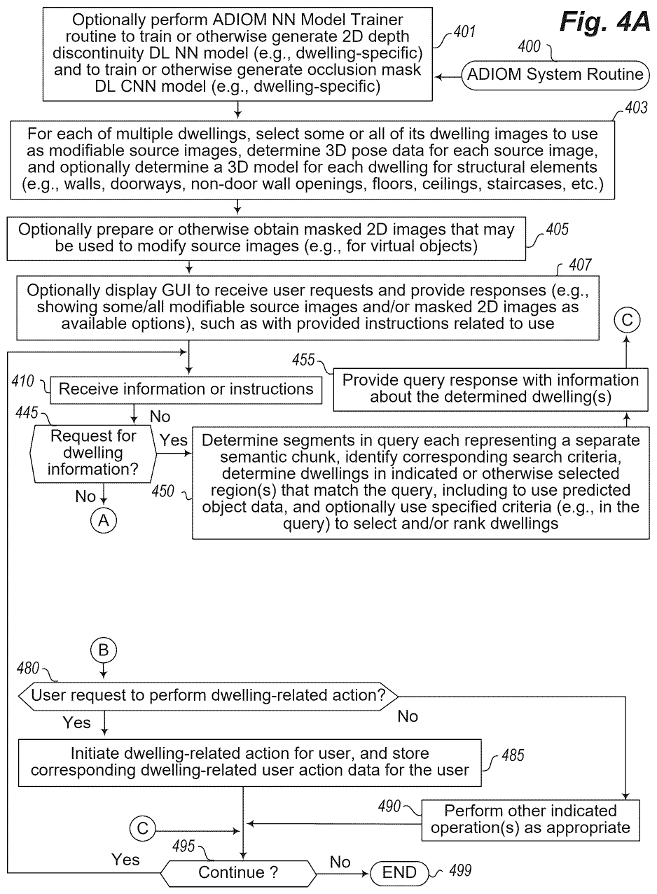

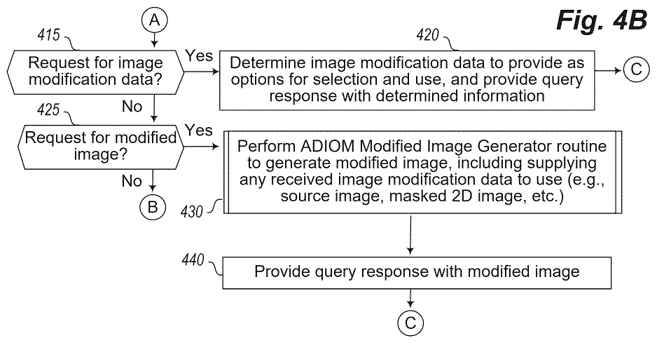

FIGS. 4A-4B are a flow diagram of an example embodiment of an ADIOM system routine 400. The routine may be performed as a computer-implemented method provided by, for example, execution of the ADIOM system 140 of FIGS. 1A-1B, and/or the ADIOM system 140 of FIG. 3, and/or corresponding functionality discussed with respect to FIGS. 2A-2C, such as to perform automated operations related to automatically generating and using modified dwelling images based on multiple trained neural network models of multiple types. In the illustrated embodiment, the routine interacts with a single user at a time, such as to provide dwelling response information to search queries and other requests from that user and/or to provide push messages with information of one or more types, but it will be appreciated that the routine may interact in a similar manner with multiple users (e.g., sequentially or concurrently), and that the routine may in other embodiments perform similar types of activities for other types of information.

In the illustrated embodiment, the routine 400 begins at block 401, where it optionally performs a ADIOM Neural Network (NN) Model Trainer routine to train or otherwise generate one or more NN models for subsequent use in generation of modified images, such as a trained depth discontinuity deep learning non-convolutional NN model (e.g., one trained in a dwelling-specific manner to determine depths for rooms and other areas found in and around dwellings) and/or a trained occlusion mask CNN model (e.g., one trained in a dwelling-specific manner to generate occlusion masks for use in adding virtual objects that are typically found in and around dwellings to source images). In at least some embodiments and situations, as part of such training of a depth discontinuity NN model and/or occlusion mask CNN model, the routine may further generate synthetic training data using available images that are captured at one or more dwellings with known room shape information (e.g., as generated from analysis of visual data of images captured at those dwelling) and that has known 3D acquisition pose information for an orientation in 3D space of a camera device at a time of capturing that image by that camera device, including in at least some embodiments and situations to train one or more such depth discontinuity NN models and/or occlusion mask CNN models that are specific to particular dwellings by using training data based on other images captured at that particular dwelling. For example, a room shape for one of the dwellings could be converted to a 3D model having some or all wall and/or ceiling and/or floor surfaces being texture-mapped from the visual data of one or more images having visual data for that room—using that room shape information (e.g., information about doors and walls that may act as occluding surfaces), a 3D furniture model (or other 3D virtual object model) could be placed on the far side of walls and doorways (relative to the camera's acquisition location of the acquisition pose) at placement locations in which they are partially occluded. Using a 3D renderer program, synthetic images may be generated from the perspective of a virtual camera having a same 3D pose as an actual image captured in that room or otherwise with visual data of that room, aiming towards the partially-occluded furniture, and with the generated synthetic images used as training data (optionally with labeling from the room shape data to show the precise locations of and corresponding pixels for the occluding surfaces from the room shapes, and/or with labeling to show the pixels for the partially-occluded furniture or other virtual object). The routine then continues to block 403 to, for multiple dwellings (e.g., some or all dwellings for which information is available in one or more geographical areas of interest), select some or all dwelling images of a dwelling to use as modifiable source images, to determine 3D acquisition pose data for such source images if not already available (e.g., based on analysis of visual data of a source image and/or of metadata acquired during image capture), and optionally determines a 3D model if not already available for a dwelling shown in the source images (e.g., using images captured throughout the rooms and other areas of such a dwelling) that indicates structural elements or otherwise determines corresponding 3D shapes of rooms or other areas visible in the source image. The routine then continues to block 405, where it optionally prepares or otherwise obtains, if not already available, masked 2D images for virtual objects that may be added to source images.

In block 407, the routine then optionally displays a GUI to a current user to receive user requests and/or provide dwelling-related information, and in block 410 receives information or instructions, such as a request from the user via the GUI. In block 445, the routine then determines if the instructions or other information received in block 405 are a request from an end-user for dwelling information, and if so continues to block 450 to determine and provide corresponding information to the end-user. In this example, the operations in block 450 include receiving a search query in a natural language form, determining segments in the query representing separate semantic chunks, identifying corresponding search criteria, determining dwellings in indicated or otherwise selected geographical regions that match the query (e.g., based at least in part on dwelling object information determined from analysis of dwelling images), including to, if user-specific search-related criteria are available, optionally further use such criteria to select and/or rank particular dwellings that are identified. In block 455, the routine then provides a query response with information about the determined dwellings.

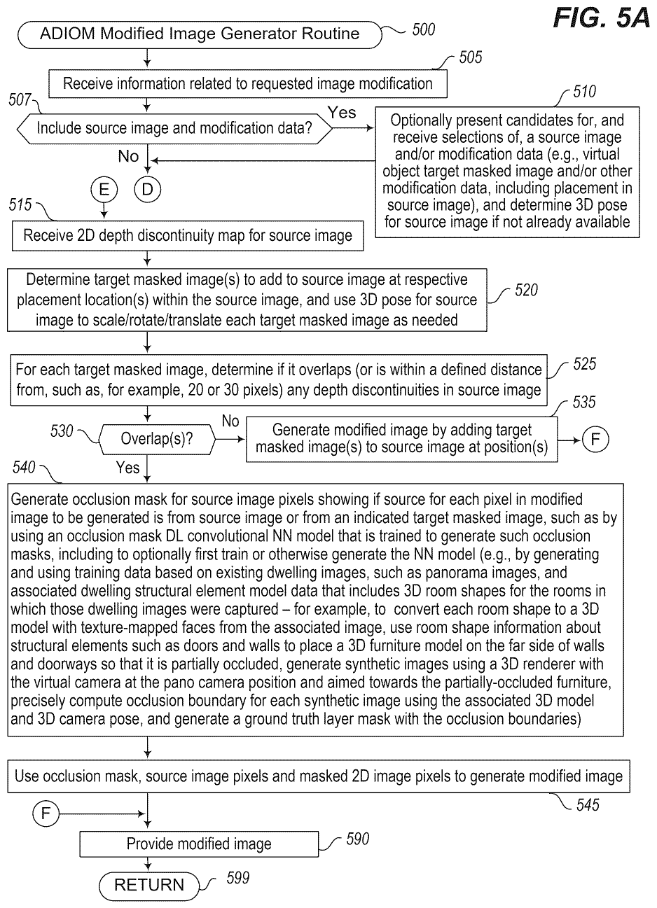

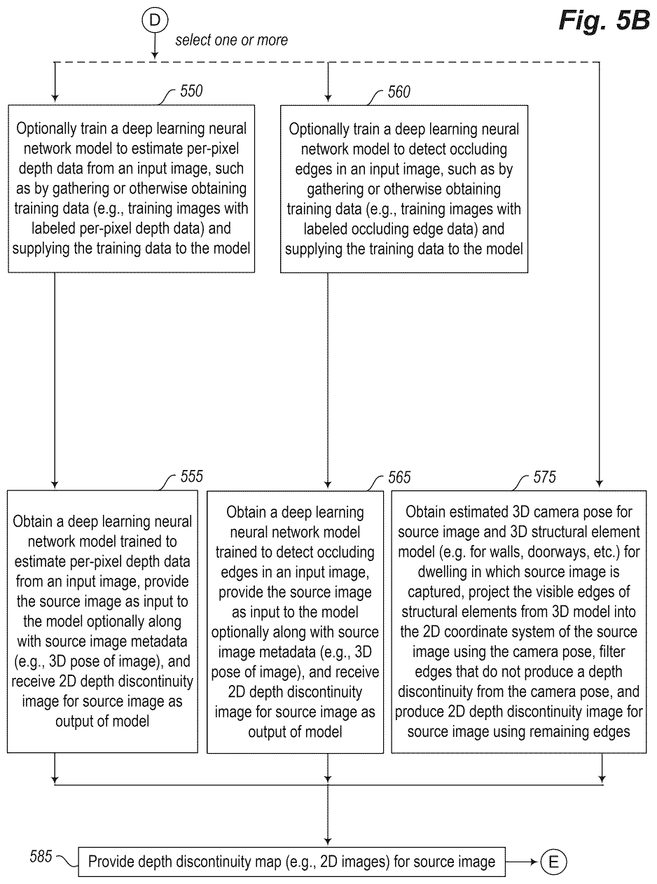

If it is instead determined in block 445 that the instructions or other information received in block 410 are not an end-user request for dwelling information, the routine continues to block 415 to determine if the instructions or other information received in block 410 are a request for image modification data of one or more types, such as candidate modification information about source images and/or virtual objects from which the user may select. If so, the routine continues to block 420 to determine and provide image modification data as options for selection that correspond to the request, and otherwise continues to block 425 to determine if the instructions or other information received in block 410 are a request to generate a modified image. If so, the routine continues to block 430 to perform an ADIOM Modified Image Generator routine to generate one or more modified images based on selected image modification data, including to supply as input to the routine any such image modification data previously selected and supplied by the user, with one example of such a routine discussed further with respect to FIGS. 5A-5B. After block 430, the routine continues to block 440 to provide a query response with the generated modified image(s) received from block 430.

If it is instead determined in block 425 that the instructions or other information received in block 410 are not a request to generate a modified image, the routine continues instead to block 480 to determine if the instructions or other information received in block 410 are a request from the user to perform one or more types of dwelling-related actions, and if so continues to block 485 to initiate the requested dwelling-related action(s) for the user as appropriate, including to store any corresponding dwelling-related user action data for the user. Such dwelling-related actions may include, for example, initiating property inspection activities, initiating dwelling repair activities, initiating dwelling financing activities, initiating dwelling agent representation activities (e.g., touring a dwelling that is available for sale or rent), etc. if it is instead determined in block 480 that the instructions or other information received in block 410 are not a request to perform one or more dwelling-related actions, the routine continues instead to block 490 to perform one or more other indicated operations as appropriate, with non-exclusive examples of such other operations including retrieving and providing previously determined or generated information (e.g., previous user queries, previously generated modified images or other previously determined responses to user queries, previous push messages, etc.), receiving and storing information for later use (e.g., information about dwelling data 321, user data 328, ADIOM system data 327, virtual object types and/or associated masked images, etc.), responding to other types of search queries (e.g., using user-specified filters), receiving and using feedback from a user in response to provided information, providing information about how one or more previous query responses were determined, providing push messages with dwelling-information to particular users if corresponding criteria are satisfied (e.g., in response to previous requests from those users for particular types of dwelling-related information, optionally with one or more specified criteria regarding when to send such push messages), performing housekeeping operations, etc.

After blocks 420, 440, 455, 485 or 490 the routine continues to block 495 to determine whether to continue, such as until an explicit indication to terminate is received (or alternatively only if an explicit indication to continue is received). If it is determined to continue, the routine returns to block 410 to await further information or instructions from the same user, and if not continues to block 499 and ends.

FIGS. 5A-5B are a flow diagram of an example embodiment of an ADIOM Modified Image Generator routine 500. The routine may be performed as a computer-implemented method provided by, for example, execution of the ADIOM Modified Image Generator component 149 of FIGS. 1A-1B and/or a corresponding component (not shown) of the ADIOM system 140 of FIG. 3 and/or with respect to corresponding functionality discussed with respect to FIGS. 2A-2C and elsewhere herein, such as to generate one or more modified images based at least in part on user-supplied instructions and optionally user-selected or otherwise user-specified modification data and/or a source image to be modified. In addition, in at least some situations, the routine 500 may be performed based on execution of block 430 of FIGS. 4A-4B, with resulting information provided and execution control returning to that location when the routine 500 ends—in other embodiments, the routine may be invoked in other manners. In this example, the routine 500 is performed using multiple particular NN models of multiple particular types, but in other embodiments may use other techniques to generate modified images, whether in addition to or instead of the illustrated types of techniques.

The illustrated embodiment of the routine 500 begins at block 505, where it receives, as input, data related to a requested image modification from a user's instructions or other supplied information, which may include instructions related to generating one or more modified images (e.g., for use in controlling the modifications performed), and optionally additional image modification data (e.g., a source image to be modified, and/or information about one or more virtual objects to be added as part of modifying the source image, optionally along with an indicated placement location for a virtual object within a room or other area visible in the source image, etc.)—in at least some embodiments and situations, some or all of the input data may be included based on selections previously made by a user from candidate options provided to the user in a GUI. In block 507, the routine determines if the data received from the user query includes a source image and sufficient image modification data to specify how to modify the source image to generate one or more resulting modified images (e.g., data of multiple defined types, such as which one or more virtual objects to add to the source image, an indicated placement location for such a virtual object, etc.), and if so proceeds to perform one or more of blocks 550, 555, 560, 565 or 575 related to determining a depth discontinuity map for a specified source image, as discussed further below. Otherwise, the routine continues to block 510, where it determines and presents candidates to the user for a source image (if not already specified) and/or for other image modification data of one or more types (if not already specified), and receives corresponding selections from the user (e.g., using dwelling images 321a; a list of virtual object types and/or associated object images, such as corresponding to objects typically visible in dwelling images or more generally associated with particular dwelling rooms or other areas; etc.), and then proceeds to perform one or more of blocks 550, 555, 560, 565 or 575 related to determining a depth discontinuity map for a specified source image.

In particular, the routine may perform at least one of blocks 555, 565 or 575 to determine a depth discontinuity map, although in other embodiments a depth discontinuity map may be received in block 505 (e.g., if the source image was previously available to the ADIOM system, such as one of multiple dwelling images that were previously captured and stored for a dwelling, and if the depth discontinuity map were previously determined or received for the source image), and if so some or all of blocks 550-585 may not be performed. When performed, the determination of the depth discontinuity map may, in at least some embodiments, in block 555 use a neural network model (e.g., a deep-learning NN) trained to estimate per-pixel depth data from an input image, by providing the source image as input to the model optionally along with source image metadata (e.g., 3D pose of image), and by receiving the 2D depth discontinuity map for the source image as output of the model—in at least some such embodiments and situations, the routine may first, in block 550, optionally train the neural network model used in block 555 to estimate per-pixel depth data from an input image, such as by gathering or otherwise obtaining training data (e.g., training images with labeled per-pixel depth data) and supplying the training data to the model. The determination of the depth discontinuity map may, in at least some embodiments, in block 565 use a neural network model (e.g., a deep-learning CNN) trained to detect occluding edges in an input image, by providing the source image as input to the model optionally along with source image metadata (e.g., 3D pose of image), and by receiving the 2D depth discontinuity map for the source image as output of the model—in at least some such embodiments and situations, the routine may first, in block 560, optionally train the neural network model used in block 565 to detect occluding edges in an input image, such as by gathering or otherwise obtaining training data (e.g., training images with labeled occluding edge data) and supplying the training data to the model. The determination of the depth discontinuity map may, in at least some embodiments, in block 575 obtain estimated 3D camera pose for the source image and a 3D room or area shape showing structural elements for a room or other area visible in the source image (e.g. for structural elements such as walls, doorways, etc., and in some cases as part of a 3D structural element model for the dwelling in which the source image is captured), project the visible edges of structural elements from the 3D room or area shape into the two-dimensional (“2D”) coordinate system of the source image using the image's acquisition pose, filter edges that do not produce a depth discontinuity from the camera pose, and produce the 2D depth discontinuity image for the source image using the remaining edges. After blocks 555, 565 and/or 575, the routine continues to block 585 to provide the determined depth discontinuity map for the source image for further use.

After block 585 (or after blocks 507 or 510 if the depth discontinuity map for the source image is already available), the routine in block 515 receives the provided depth discontinuity map from block 505 or 585, and in block 520 then determines one or more target masked images to add to the source image at one or more respective placement locations within the source image (e.g., as specified in blocks 505 or 510, by retrieving and/or generating target masked images for one or more objects or object types indicated in blocks 505 or 510, etc.), and uses 3D pose data for the source image to scale/rotate/translate a virtual object's visual representation in a corresponding target masked image as needed. In block 525, for a target masked image, the routine determines if the visual representation of the virtual object within it (e.g., not including any transparent pixels of the target masked image) overlaps (e.g., within any defined distance threshold, such as 1 pixel or 5 pixels or 10 pixels or 15 pixels or 20 pixels or 25 pixels or 30 pixels or any intermediate pixel value between those values) with any depth discontinuities in the source image. In block 530, the routine then determines if any such overlaps exist, and if not, proceeds to block 535 to generate a modified image by adding the target masked image(s) to the source image at the respective placement location(s). Otherwise, in block 540, the block generates an occlusion mask for the source image's pixels showing if the source for a pixel in the modified image is to come from the source image or from an indicated target masked image. In block 545, the block then uses the occlusion mask, source image's pixels and pixels of the target masked image(s) to generate the modified image. After blocks 535 or 545, the routine then provides the modified image(s) as output in block 590, and continues to block 599 and returns.

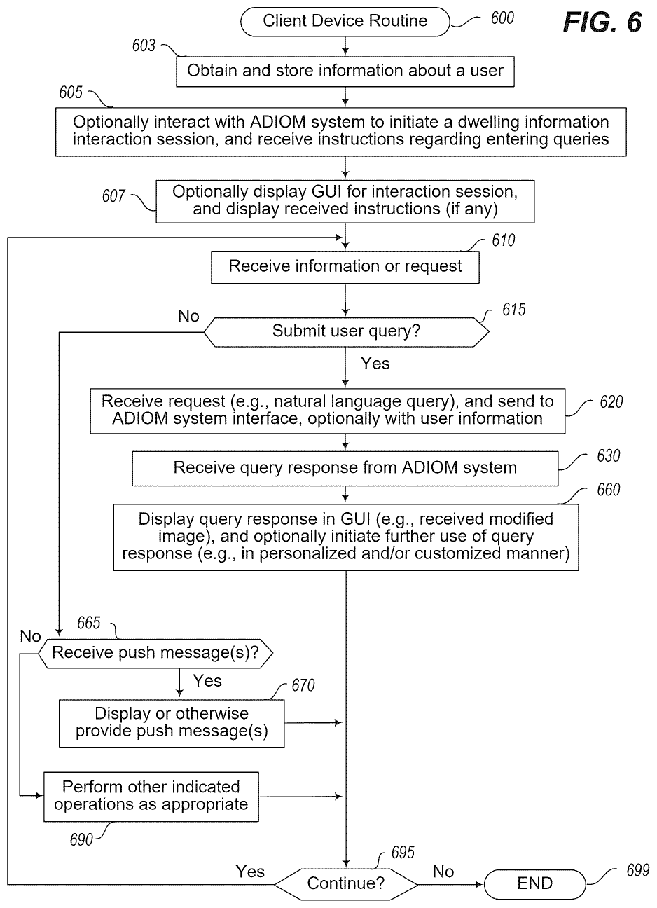

FIG. 6 is a flow diagram of an example embodiment of a client device routine 600. The routine may be performed as a computer-implemented method provided by, for example, operations of a client computing device 360 of FIGS. 1A-1B and/or a client computing device 360 of FIG. 3 and/or with respect to corresponding functionality discussed with respect to FIGS. 2A-2C and elsewhere herein, such as to interact with users or other entities who submit queries (or other requests or information) to the ADIOM system, to receive responsive answers (or other information, including generated modified images) from the ADIOM system, and to optionally use the received information in one or more manners (e.g., to automatically initiate follow-up activities in accordance with a received responsive answer or other received information).

The illustrated embodiment of the routine 600 begins at block 603, where information is optionally obtained and stored about the user, such as for later use in personalizing or otherwise customizing further actions to that user. The routine then continues to block 605 to optionally interact with the ADIOM system to initiate an interaction session (e.g., in response to a corresponding instruction from the user), as well as to optionally receive a greeting and/or introductory instructions regarding using a GUI of the ADIOM system, such as by displaying a GUI for the interaction session in block 607 in which the received greeting and/or introductory instructions (if any) are optionally displayed, as well as listing various selections for use as search criteria and/or browsing filter criteria and/or related to generating modified images. The routine then continues to perform blocks 610-690 as part of participating in the interaction session or otherwise receiving push messages sent from the ADIOM system.

In particular, the routine continues to block 610 after block 607, where it waits until information or a request is received from the user. In block 615, the routine determines if the information or request received in block 610 is a request to be submitted, such as a search query (e.g., in a natural language format, such as freeform text) or browse query or a request related to generating a modified image, and if not continues to block 665. Otherwise, the routine continues to block 620, where it sends the received query to the ADIOM system interface, optionally along with additional information about the user from block 603, to obtain a corresponding responsive answer-in other embodiments, the routine may further modify the received user query to personalize and/or customize the information to be provided to the ADIOM system (e.g., to add information specific to the user, such as location, demographic information, preference information, etc.). In block 630, the routine then receives a responsive answer to the query from the ADIOM system, and in block 660 displays the received query response in the GUI (e.g., a generated modified image), and optionally initiates further use of the query response in one or more manners (e.g., in a manner that is personalized and/or customized for the user)—in some embodiments, the further initiated activities may include invoking of other functionality of the ADIOM system for a user-initiated dwelling-related action, such as to initiate an inspection process for a selected dwelling indicated in dwelling information search results, to initiate a mortgage application process for a selected dwelling indicated in dwelling information search results, to initiate matching the user with a real estate professional as part of a housing search based on corresponding response information received from the ADIOM system, etc.

In block 665, the routine determines if the information or request received in block 610 is one or more push electronic messages sent by the ADIOM system, and if so continues to block 670 to display or otherwise provide the received electronic messages to the user (e.g., stores the received electronic messages in a queue for later retrieval by the user)—in some embodiments and situations, such a displayed or otherwise provided electronic message may include one or more user-selectable controls that, if selected by the user, initiate further interactions with the ADIOM system or otherwise initiate further activities of one or more types. If it is instead determined in block 665 that the information or request received in block 610 is not one or more push electronic messages, the routine continues to block 690 to instead perform one or more other indicated operations as appropriate, with non-exclusive examples including sending information to the ADIOM system of other types (e.g., based on selections by the user of provided user-selectable controls), receiving and storing user data for later use in personalization and/or customization activities, receiving and responding to requests for information about previous user queries and/or corresponding responsive answers for a current user and/or client device, receiving and responding to indications of one or more housekeeping activities to perform, etc. After blocks 660, 670 or 690, the routine continues to block 695 to determine whether to continue, such as until an explicit indication to terminate is received (or alternatively only if an explicit indication to continue is received). If it is determined to continue, the routine returns to block 610, and if not continues to block 699 and ends.

It will be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, synchronously or asynchronously, etc.) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the claims that are specified and the elements recited therein. In addition, while certain aspects of the invention may be presented at times in certain claim forms, the inventors contemplate the various aspects of the invention in any available claim form. For example, while only some aspects of the invention may be recited at a particular time as being embodied in a computer-readable medium, other aspects may likewise be so embodied.

What is claimed is:

1. A computer-implemented method comprising:
obtaining, by one or more computing devices, indications of a source image that is captured in a room of a dwelling and has visual data including a plurality of pixels and does not have associated depth data captured in the room from an acquisition location in the room at which the source image was acquired, and of modification data for the source image including an image of a virtual object that is to be added to the source image at an indicated placement in the room causing a subset of the virtual object to be visually occluded by one or more visible intervening surfaces in the room between a location of the indicated placement and the acquisition location;
determining, by the one or more computing devices and using a first trained neural network model that receives as input at least the source image, a depth discontinuity map for the source image that indicates adjacent pixels of the plurality of pixels corresponding to transitions from visible edges in the source image of occluding surfaces to other surfaces behind the occluding surfaces in the source image, the occluding surfaces including the one or more visible intervening surfaces;
determining, by the one or more computing devices, a masked image of the virtual object having multiple pixels, wherein some or all of the multiple pixels are non-transparent pixels showing a visualization of the virtual object that is scaled and rotated and translated to correspond to the indicated placement in the room as visible in the source image;
determining, by the one or more computing devices and using a second trained neural network model that receives as input at least the depth discontinuity map, an occlusion mask for the source image having indications of, for a modified version of the source image that includes the virtual object added at the indicated placement, a first subset of pixels of the modified version of the source image that are associated with the virtual object are to come from corresponding pixels of the masked image of the virtual object, and a second subset of the pixels of the modified version of the source image that are not associated with the virtual object are to come from corresponding pixels of the source image;
generating, by the one or more computing devices, the modified version of the source image using pixels from the source image and from the masked image of the virtual object according to the occlusion mask; and
presenting, by the one or more computing devices, the modified version of the source image.

2. The computer-implemented method of claim 1 wherein the first neural network model is trained to estimate per-pixel depth values for pixels of an image using a three-dimensional (3D) pose for that image of a camera device during capturing of that image, and to identify transitions between multiple surfaces visible in that image based at least in part on the estimated per-pixel depth values for pixels on edges between the multiple surfaces differing by at least a defined threshold amount, and wherein the determining of the depth discontinuity map for the source image using the trained first neural network model includes estimating respective per-pixel depth values for the plurality of pixels of the source image using a determined 3D pose for the source image, and using the estimated respective per-pixel depth values to identify the adjacent pixels in the source image corresponding to the transitions from the visible edges in the source image of the occluding surfaces to the other surfaces behind the occluding surfaces in the source image.

3. The computer-implemented method of claim 2 wherein the first neural network model is a non-convolutional deep-learning neural network model, and wherein the method further comprises performing, by the one or more computing devices and before the determining of the depth discontinuity map for the source image, training of the first neural network model using training data for a plurality of captured images, wherein the plurality of captured images for the training data are selected from images captured at the dwelling to train the first neural network model specific to the dwelling.

4. The computer-implemented method of claim 2 further comprising capturing the source image at the acquisition location in the room, and determining, by the one or more computing devices and based at least in part on analysis of visual data of the source image, the 3D pose for the source image.

5. The computer-implemented method of claim 1 wherein the first neural network model is trained to identify edges of multiple surfaces visible in an image, and to use the identified edges as transitions between the multiple surfaces, and wherein the determining of the depth discontinuity map for the source image using the trained first neural network model includes detecting edges of at least the occluding surfaces in the source image, and using the detected edges as the transitions in the source image from the occluding surfaces to the other surfaces behind the occluding surfaces in the source image.

6. The computer-implemented method of claim 5 wherein the first neural network model is a non-convolutional deep-learning neural network model, and wherein the method further comprises performing, by the one or more computing devices and before the determining of the depth discontinuity map for the source image, training of the first neural network model using training data for a plurality of captured images, wherein the plurality of captured images for the training data are selected from images captured at the dwelling to train the first neural network model specific to the dwelling.

7. The computer-implemented method of claim 1 wherein the second neural network model is trained to use a supplied depth discontinuity map that is for an indicated image and that has indicated pairs of pixels corresponding to visible edges between surfaces in that image to generate an occlusion mask indicating sources for pixel of a modified version of the indicated image comes from the indicated image or from another image, and wherein the determining of the occlusion mask for the source image using the trained second neural network model includes using the adjacent pixels in the depth discontinuity map for the source image corresponding to the transitions to indicate sources for pixels in the modified version of the source image from the source image or the masked image of the virtual object.

8. The computer-implemented method of claim 1 wherein the second neural network model is a convolutional neural network model, and wherein the method further comprises performing, by the one or more computing devices and before the determining of the occlusion mask for the source image using the trained second neural network model, training of the second neural network model using training data including supplied depth discontinuity maps for a plurality of captured images, wherein the plurality of captured images for the training data are selected from images captured at the dwelling to train the second neural network model specific to the dwelling.

9. The computer-implemented method of claim 1 further comprising determining, by the one or more computing devices and by supplying the source image and the image of the virtual object as input to a trained diffusion machine learning model, the indicated placement in the room of the virtual object as output of the trained diffusion machine learning model.

10. The computer-implemented method of claim 1 further comprising generating, by the one or more computing devices and before the using of the first or second trained neural network models, training data by using existing images captured in one or more dwelling rooms and room shape data for the one or more dwellings to render new synthetic images in which one or more virtual objects are added at locations in which part of the one or more virtual objects is occluded by one or more surfaces of structural elements from the room shape data, and using the rendered new synthetic images as part of training at least one of the first neural network model or the second neural network model.

11. The computer-implemented method of claim 1 wherein the determining of the masked image includes using the image of the virtual object to produce the masked image with a same quantity and arrangement of masked image pixels as the plurality of pixels of the source image, with a subset of the masked image pixels being non-transparent pixels representing the virtual object at the indicated placement and as scaled and rotated and translated to correspond to the indicated placement, and with other of the masked image pixels outside the subset being transparent pixels.

12. The computer-implemented method of claim 1 wherein the virtual object is one of a piece of movable furniture or a structural element that is part of the room, and wherein the determining of the masked image includes using a trained diffusion model to generate the masked image from the image of the virtual object and using information about the indicated placement in the room.

13. The computer-implemented method of claim 1 wherein the obtaining of the indications of the source image and the modification data includes at least one of:
presenting, by the one or more computing devices, multiple candidate source images captured at the dwelling, and receiving a selection of the source image from the presented multiple candidate source images; or
presenting, by the one or more computing devices, multiple candidate images of multiple candidate virtual objects, and receiving a selection of the image of the virtual object from the presented multiple candidate images; or
presenting, by the one or more computing devices, multiple candidate categories of multiple candidate virtual objects, and receiving a selection of a category of the virtual object from the presented multiple candidate categories, and generating or retrieving the image of the virtual object using the selected category; or
receiving, by the one or more computing devices, a supplied copy of the source image from a client device in the room of the dwelling, and wherein the presenting of the modified version of the source image includes displaying the modified version of the source image on the client device; or
receiving, by the one or more computing devices, a textual or spoken description of the virtual object, and generating or retrieving the image of the virtual object.

14. The computer-implemented method of claim 1 further comprising:
obtaining, by the one or more computing devices, indications of additional modification data for the source image including a second indicated placement in the room of the virtual object;
determining, by the one or more computing devices and using the depth discontinuity map for the source image, that the second indicated placement in the room of the virtual object does not cause any of the virtual object to be visually occluded by any visible intervening surfaces in the room;
generating, by the one or more computing devices and without using the occlusion mask, a second modified version of the source image that includes a visual representation of the virtual object being overlaid on the source image based on the second indicated placement; and
presenting, by the one or more computing devices, the second modified version of the source image.

15. A system comprising:
one or more hardware processors of one or more computing systems; and
one or more memories with stored instructions that, when executed by at least one of the one or more hardware processors, cause the one or more computing systems to perform automated operations including at least:
obtaining indications of a source image captured at an acquisition location in a room of a dwelling and having visual data including a plurality of pixels, and of modification data for the source image including a representation of a virtual object that is to be added to the source image at a placement location in the room resulting in a subset of the virtual object being visually occluded by an intervening surface between the placement location and the acquisition location;
determining a depth discontinuity map for the source image that indicates some pixels of the plurality of pixels corresponding to transitions from visible edges in the source image of one or more first surfaces to one or more other second surfaces behind the one or more first surfaces in the source image, the one or more second surfaces including the intervening surface;
obtaining, using the representation of the virtual object, a masked image of the virtual object having multiple non-transparent pixels showing a visualization of the virtual object that is scaled and rotated to correspond to the placement location for the source image;
determining, using a trained neural network model that receives as input at least the depth discontinuity map, an occlusion mask for the source image having indications of, for a modified version of the source image that includes the virtual object added at the placement location, a first subset of pixels of the modified version of the source image that are associated with the virtual object are to come from corresponding pixels of the masked image of the virtual object, and a second subset of the plurality of pixels that are not associated with the virtual object are to come from corresponding pixels of the source image;
generating the modified version of the source image using pixels from the source image and from the masked image of the virtual object according to the occlusion mask; and
providing the modified version of the source image for display.

16. The system of claim 15 wherein the obtaining of the masked image of the virtual object includes generating, using a trained diffusion machine learning model, the masked image of the virtual object based on the included representation and the placement location in the room.

17. The system of claim 15 wherein the stored instructions include software instructions that, when executed, cause the at least one hardware processor to perform further automated operations including performing the determining of the depth discontinuity map by at least one of:
using a first trained deep learning neural network model that receives as input at least the source image and that estimates per-pixel depth data for the plurality of pixels of the source image, and identifying the some pixels using adjacent pixels having differences between their estimated per-pixel depth data that is above a defined threshold amount; or
using a second trained deep learning neural network model that receives as input at least the source image and that detects occluding edges, and identifying the some pixels along the detected occluding edges; or
projecting, using an estimated three-dimensional (3D) camera pose for the source image and a 3D room model showing structural elements of the room, visible edges of the structural elements into a two-dimensional coordinate system of the source image, identify one or more of the projected visible edges as producing a depth discontinuity, and identifying the some pixels along the identified one or more projected visible edges; or
using depth data captured in the room from an acquisition location in the room at which the source image was acquired to determine per-pixel depth data for the plurality of pixels of the source image, and identifying the some pixels using adjacent pixels having differences between their estimated per-pixel depth data that is above a defined threshold amount.

18. The system of claim 15 wherein the representation of the virtual object is one of an image of the virtual object or a three-dimensional model of the virtual object, wherein the virtual object is one of a piece of movable furniture or a structural element that is part of the room, wherein the source image does not have associated depth data captured in the room from an acquisition location in the room at which the source image was acquired, wherein the modification data includes an indication of the placement location, wherein the one or more first surfaces occlude at least some of the one or more second surfaces, and wherein the providing of the modified version of the source image includes displaying the modified version of the source image.

19. A non-transitory computer-readable medium having stored contents that cause one or more computing devices to perform automated operations including at least:
obtaining, by the one or more computing devices, indications of a source image captured at an acquisition location in an area of a dwelling and having visual data including a plurality of pixels, and of modification data for the source image identifying a virtual object to be added to the source image at a placement location in the area that results in a subset of the virtual object being visually occluded by an intervening surface visible in the source image between the placement location and the acquisition location;
obtaining, by the one or more computing devices, a depth discontinuity map for the source image that indicates some pixels of the plurality of pixels corresponding to transitions from visible edges in the source image of first surfaces to other second surfaces behind the first surfaces in the source image, the second surfaces including the intervening surface;
obtaining, by the one or more computing devices, a masked image of the virtual object having multiple non-transparent pixels showing a visualization of the virtual object that is scaled and rotated to correspond to the placement location for the source image;
determining, by the one or more computing devices and using a trained neural network model that receives as input at least the depth discontinuity map, an occlusion mask for the source image having indications of, for a modified version of the source image that includes the virtual object added at the placement location, a first subset of pixels of the modified version of the source image that are associated with the virtual object are to come from corresponding pixels of the masked image of the virtual object, and a second subset of the pixels of the modified version of the source image that are not associated with the virtual object are to come from corresponding pixels of the source image;
generating, by the one or more computing devices, the modified version of the source image using pixels from the source image and from the masked image of the virtual object according to the occlusion mask; and
providing the modified version of the source image for display.

20. The non-transitory computer-readable medium of claim 19 wherein the modification data identifying the virtual object is one of an image of the virtual object or a three-dimensional model of the virtual object or a textual description of the virtual object or a verbal description of the virtual object, wherein the area of the dwelling is a room of the dwelling, wherein the virtual object is one of a piece of movable furniture or a structural element that is part of the room, wherein the source image does not have associated depth data captured in the room from an acquisition location in the room at which the source image was acquired, wherein the modification data includes an indication of the placement location, wherein the one or more first surfaces occlude at least some of the one or more second surfaces, wherein the obtaining of the depth discontinuity map includes generating the depth discontinuity map using an analysis of visual data of the source image, and wherein the providing of the modified version of the source image includes displaying the modified version of the source image.
